(19) United States
(12) Patent Application Publication
(10) Pub. No.: US 2025/0271726 A1
(43) Pub. Date: Aug. 28, 2025

(54) COMPOUND WAVEGUIDE STRUCTURE WITH ELECTRO-OPTIC MATERIAL CORE, PREPARATION METHOD, AND USE THEREOF

(71) Applicant: TROE PHOTONICS, HANGZHOU, LTD., Hangzhou City (CN)

(72) Inventors: Ziqiang ZHAO, Hangzhou (CN); Zihao SHAN, Hangzhou (CN); Jiafan YANG, Hangzhou (CN); Jinxi HUANG, Hangzhou (CN)

(21) Appl. No.: 19/206,075

(22) Filed: May 13, 2025

Related U.S. Application Data
(63) Continuation of application No. PCT/CN2023/124357, filed on Oct. 12, 2023.

(30) Foreign Application Priority Data
Nov. 14, 2022 (CN) 202211419671.2

(51) Int. Cl. G02F 1/365

(52) U.S. Cl. CPC G02F 1/365

(57) ABSTRACT

Provided are a compound waveguide structure with an electro-optic material core, a preparation method and use thereof. The compound waveguide structure comprises a silicon substrate layer, an insulator, and a silicon-rich silicon nitride cladding structure from bottom to top. The silicon-rich silicon nitride cladding structure is formed by encapsulating an electro-optic material core within a silicon-rich silicon nitride layer. The material of the electro-optic material core is characterized by its ability to alter the refractive index in directionally applied electric fields. This compound waveguide structure can reduce sidewall roughness caused by etching processes. The method features simple preparation, low environmental requirements, and cost-effectiveness, making it applicable to the preparation of optoelectronic chips with various optoelectronic device structures.

### CROSS-REFERENCE TO RELATED APPLICATIONS

This application is a continuation of International Application No. PCT/CN2023/124357, filed on Oct. 12, 2023, which claims priority to Chinese Application No. 202211419671.2, filed on Nov. 14, 2022, the contents of both of which are incorporated herein by reference in their entireties.

### TECHNICAL FIELD

The present disclosure belongs to the field of semiconductor processes and materials, and in particular, to a compound waveguide structure with an electro-optic material core, a preparation method and use thereof. This compound waveguide structure can be used in the design and preparation of large-scale on-chip integrated optoelectronic device structures.

### BACKGROUND

The concept of integrated optics is based on using micro/nano-etching techniques on planar substrates to form a specific optical waveguide structure. Based on this concept, a photoelectric active/passive platforms integrated with silicon (Si) as a waveguide material has been realized.

Electro-optic material crystals represented by lithium niobate exhibit large nonlinear optical coefficients, along with excellent photorefractive, piezoelectric, and acoustic properties, making them suitable for frequency doubling/difference frequency crystal materials. They possess outstanding physical and mechanical performance, high damage thresholds, broad transparent spectra, and extremely low optical loss. Additionally, the relatively reduced cost of electro-optic materials makes them highly suitable for fabricating optical modulators. Compared to traditional electro-optic modulation chips based on CMOS (complementary metal oxide semiconductor) technology, which is represented by silicon (Si), the nonlinear characteristics of electro-optic material crystals have shown particularly promising prospects in recent years for research and applications related to optical frequency combs. With technological advancements, these electro-optic crystals can also be integrated in thin-film form on 6-inch or even larger wafer surfaces. Taking lithium niobate on insulator (LNOI) as an example, its emergence has addressed the low integration density and polarization crosstalk issues in traditional electro-optic material waveguides, further simplifying the conditions for generating nonlinear effects in such waveguides.

However, etching these electro-optic material thin films has remained an engineering challenge. For instance, the etching process for lithium niobate crystals introduces lithium and niobium ions into the reaction chamber, and the resulting rough sidewalls cannot be further improved by adjusting the etching recipe. A common practice is to employ a specialized damascene process after etching, using chemical mechanical polishing to smooth the etched sidewalls and the rough top surface. However, the limitation of this method lies in the fact that when the chip structure's duty cycle is too small, the densely stacked gap structures may make it difficult to restore smooth sidewalls through polishing or chemical planarization. These gap structures are often used as optical coupling regions, and excessively rough sidewalls can significantly reduce optical coupling efficiency.

Unlike electro-optic material crystals, silicon-rich silicon nitride is typically prepared through deposition processes by adjusting the ratio of silicon source to ammonia source to achieve silicon nitride materials with varying silicon/nitrogen compositions. Its refractive index can be altered based on the silicon content, with typical values ranging from 2.0 to 2.9. For instance, lithium niobate has a refractive index of 2.0-2.5 in the short-wave infrared (SWIR) range, which falls within the refractive index variation range of silicon-rich silicon nitride. In CMOS processes, growing silicon-rich silicon nitride with different composition ratios serves as a flexible means to modulate gate barriers. In CMOS-based integrated photonic applications, silicon nitride's low transmission loss, higher real part of refractive index compared to silicon oxide, and strong third-order nonlinear coefficients make it highly valuable for applications like integrated optical frequency combs and narrow-linewidth lasers. However, silicon nitride lacks electro-optic and second-order nonlinear effects, which limits its potential as a promising integrated photonic platform. Compared to electro-optic materials, silicon-rich silicon nitride offers mature and stable dry etching processes and can repair rough sidewalls caused by etching through hydrogen annealing.

### SUMMARY

To address the rough surfaces formed during dry etching of electro-optic material waveguides, the present disclosure provides a compound waveguide structure with an electro-optic material core, along with a preparation method and use thereof. Unlike traditional approaches such as hydrogen oxidation or damascene polishing for improving waveguide sidewall smoothness, the present disclosure employs a silicon-rich silicon nitride cladding to achieve refractive index matching with the electro-optic material core, enabling the preparation of a cladding-core compound waveguide structure.

According to a first aspect of the present disclosure, a compound waveguide structure with an electro-optic material core is provided, including a silicon substrate layer, an insulator, and a silicon-rich silicon nitride cladding structure from bottom to top. The silicon-rich silicon nitride cladding structure is formed by encapsulating an electro-optic material core within a silicon-rich silicon nitride layer, where the material of the electro-optic material core is characterized by its ability to alter its refractive index in directionally applied electric fields.

According to a second aspect of the present disclosure, a preparation method for the compound waveguide structure with the electro-optic material core is provided, including the following steps:
S1, providing an electro-optic-film-on-insulator wafer;
S2, forming a first mask layer on the electro-optic-film-on-insulator wafer;
S3, transferring a waveguide core pattern formed on the first mask layer to an electro-optic material layer of the electro-optic-film-on-insulator wafer by dry etching after lithographing to form an electro-optic material core;
S4, removing the first mask layer, and forming a silicon-rich silicon nitride layer around and on top of the electro-optic material core;
S5, performing a planarization treatment on the silicon-rich silicon nitride layer to obtain a smooth wafer surface;
S6, forming a second mask layer on the silicon-rich silicon nitride layer and transferring the optical waveguide pattern to the second mask layer by lithographing;
S7, transferring the optical waveguide pattern on the second mask layer to the silicon-rich silicon nitride layer by etching to form a silicon-rich silicon nitride cladding structure; and
S8, removing the second mask layer and cleaning the electro-optic-film-on-insulator wafer to obtain the compound waveguide structure with the electro-optic material core.

Further, a silicon-rich silicon nitride material in the silicon-rich silicon nitride layer must satisfy refractive index matching with an electro-optic material in the electro-optic material core.

Further, a composition of silicon-rich silicon nitride is adjusted based on a measured refractive index of the electro-optic material core to achieve the refractive index matching, which meets the following conditions:

$$\vert {n}_{silicon - rich silicon nitride} ( x , y , λ ) - {n}_{electro - optic material} ( λ ) \vert \leq 0.1$$

where n_{silicon-rich silicon nitride} represents a real part of a material refractive index of the silicon-rich silicon nitride, n_{electro-optic material} (λ) represents a real part of a material refractive index of the electro-optic material, x represents a silicon content ratio in the silicon-rich silicon nitride, y represents a nitrogen content ratio in the silicon-rich silicon nitride, and λ represents an operating optical wavelength designed for the waveguide structure.

Further, the electro-optic material core does not need to be entirely contained within the silicon-rich silicon nitride cladding structure; and based on the optical waveguide pattern designed for an application scenario of the waveguide structure, selective adjustment is made to determine whether the silicon-rich silicon nitride cladding structure contains the electro-optic material core.

Further, the electro-optic-film-on-insulator wafer sequentially includes a silicon substrate layer, an insulator, and the electro-optic material layer from bottom to top; and the electro-optic material layer is prepared through He⁺ or H+ ion implantation followed by heating and delamination, without the need for subsequent chemical mechanical polishing to achieve a flat surface.

Further, the first mask layer is configured to form the electro-optic material core having a sufficient thickness step, and the second mask layer must ensure that the remaining second mask layer uniformly and integrally covers the silicon-rich silicon nitride layer after an etching process.

Further, the electro-optic material core is formed by bombardment of an Ar⁺ plasma, and a top portion of the electro-optic material core is capable of withstanding over-etching caused by excessive bombardment of the Art plasma.

According to a third aspect of the present disclosure, a use of the compound waveguide structure with the electro-optic material core prepared by the above-mentioned method in optoelectronic devices is provided. Optical phase adjustment is implemented using planar electrodes through an electro-optic effect provided by the electro-optic material core.

According to a fourth aspect of the present disclosure, use of the compound waveguide structure with the electro-optic material core prepared by the above-mentioned method in optoelectronic devices is provided. The electro-optic material core serves as a nonlinear optical gain material, to implement optical frequency mixing and optical difference/doubling frequency functionality by introducing the nonlinear optical effect.

The beneficial effects of the present disclosure are as follows: the need for grinding treatment on the surface and sidewalls of the electro-optic material waveguide is eliminated, and by introducing an outer cladding structure made of silicon-rich silicon nitride, the etching difficulty of the waveguide sidewalls is reduced, making it easier to obtain smooth waveguide sidewalls. The preparation method for the waveguide structure provided by the present disclosure features simple processes, low cost, and compatibility with CMOS technology, making it highly suitable for the design and preparation of large-scale nonlinear optoelectronic chips.

### BRIEF DESCRIPTION OF DRAWINGS

FIG. 1 is a schematic diagram of a compound waveguide structure with an electro-optic material core provided by the present disclosure;

FIG. 2 is a preparation flowchart of a compound waveguide structure with an electro-optic material core provided by the present disclosure;

FIG. 3(a) is a schematic diagram of preparation step S1 provided by an embodiment of the present disclosure, FIG. 3(b) is a schematic diagram of preparation step S2 provided by an embodiment of the present disclosure, FIG. 3(c) is a schematic diagram of preparation step S3 provided by an embodiment of the present disclosure, and FIG. 3(d) is a schematic diagram of preparation step S4 provided by an embodiment of the present disclosure;

FIG. 4(a) is a schematic diagram of preparation step S5 provided by an embodiment of the present disclosure, FIG. 4(b) is a schematic diagram of preparation step S6 provided by an embodiment of the present disclosure, FIG. 4(c) is a schematic diagram of preparation step S7 provided by an embodiment of the present disclosure, and FIG. 4(d) is a schematic diagram of preparation step S8 provided by an embodiment of the present disclosure;

FIG. 5(a) is a schematic diagram of the exposed electro-optic material waveguide mode provided by an embodiment of the present disclosure, FIG. 5(b) is a schematic diagram of the cladding electro-optic material waveguide mode provided by an embodiment of the present disclosure;

FIG. 6(a) is an example of a device structure based on the cladding electro-optic material waveguide of a Mach-Zehnder configuration provided by an embodiment of the present disclosure; and

FIG. 6(b) is an example of a device structure based on the cladding electro-optic material waveguide of a micro-ring configuration provided by an embodiment of the present disclosure;

### REFERENCE SIGNS

101, Silicon substrate layer; 102, Insulator; 103, Silicon-rich silicon nitride layer; 104, Electro-optic material layer; 105, Electro-optic material core; 110, Electro-optic-film-on-insulator wafer; 301, First mask layer; 401, Second mask layer; 402, Silicon-rich silicon nitride cladding structure; 501, Silicon-rich silicon nitride waveguide structure; 502, Planar electrode.

### DESCRIPTION OF EMBODIMENTS

To make the above objectives, features, and advantages of the present disclosure more comprehensible, the detailed embodiments of the present disclosure are described below with reference to the drawings.

Numerous specific details are set forth in the following description to facilitate a thorough understanding of the present disclosure. However, the present disclosure may also be implemented in other ways different from those described herein. Those skilled in the art can make similar extensions without departing from the spirit of the present disclosure. Therefore, the present disclosure is not limited by the specific embodiments disclosed below.

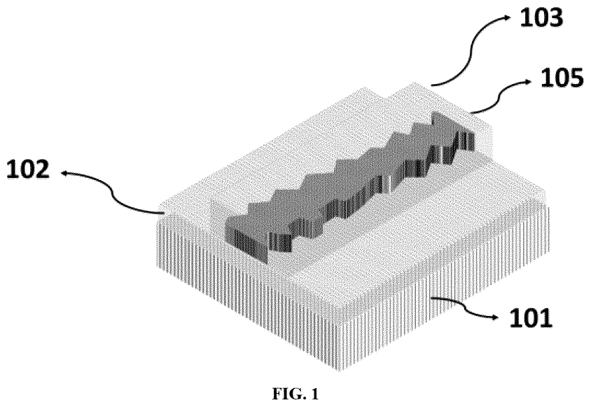

As shown in FIG. 1, an embodiment of the present disclosure provides a compound waveguide structure with an electro-optic material core. The compound waveguide structure includes, from bottom to top, a silicon substrate layer 101, an insulator 102, and a silicon-rich silicon nitride cladding structure 402. The silicon-rich silicon nitride cladding structure 402 is formed by encapsulating the electro-optic material core 105 within the silicon-rich silicon nitride layer 103. The material of the electro-optic material core 105 is characterized by its ability to alter the refractive index in directionally applied electric fields.

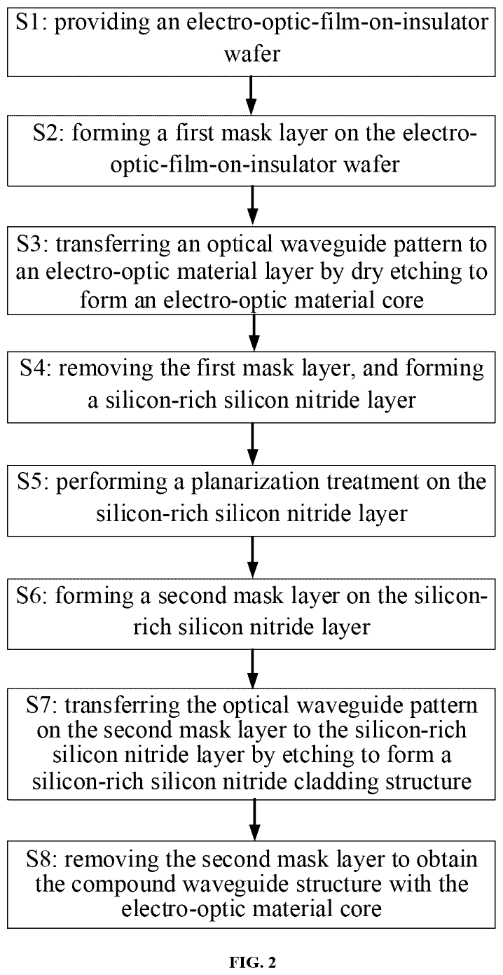

In another embodiment, a method for preparing the compound waveguide structure with an electro-optic material core is provided. As shown in FIG. 2, the method includes the following steps:

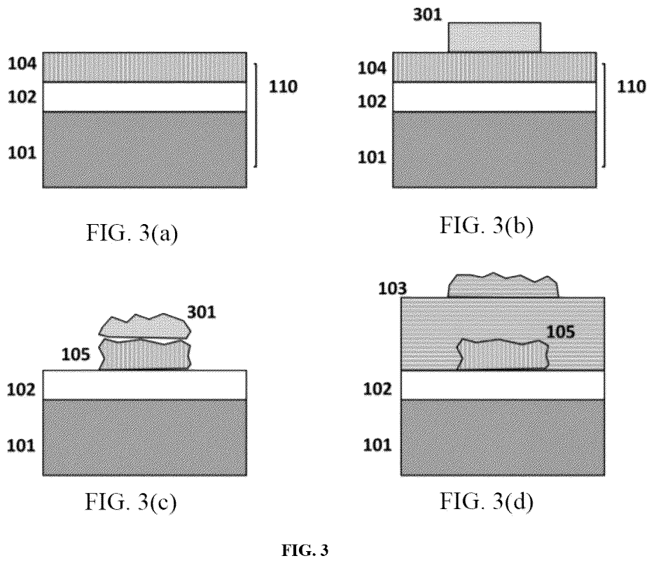

S1: As shown in FIG. 3(a), an electro-optic-film-on-insulator wafer 110 is provided. The electro-optic-film-on-insulator wafer 110 consists of the following three-layer structure, with preferred thicknesses given: an electro-optic material layer 104, with a thickness of 0.1-1 micrometers; the insulator 102, which may use silicon oxide, with a thickness of 1-10 micrometers; and the silicon substrate layer 101, with a thickness of 100-1000 micrometers.

In an embodiment, the size of the electro-optic-film-on-insulator wafer 110 ranges from 2 to 12 inches.

In an embodiment, the electro-optic material layer 104 on the electro-optic-film-on-insulator wafer 110 can be prepared by He⁺ or H+ ion implantation followed by heating and delamination.

In an embodiment, the electro-optic material layer 104 on the electro-optic-film-on-insulator wafer 110 does not require prior chemical mechanical polishing to achieve a flat surface.

In an embodiment, the electro-optic material layer 104 on the electro-optic-film-on-insulator wafer 110 can be directly thinned to the desired thickness through dry/wet etching.

S2: As shown in FIG. 3(b), a first mask layer 301 is formed on the electro-optic-film-on-insulator wafer 110.

In an embodiment, a required optical waveguide pattern can be formed for the first mask layer 301 by using photoresist or electron beam resist through steps such as spin-coating, curing, exposure, and development.

In an embodiment, the first mask layer 301 can adopt a barrier material with a smaller etching selectivity ratio difference compared to the electro-optic material.

In an embodiment, the first mask layer 301 has lower thickness requirements for photoresist or electron beam resist.

S3: As shown in FIG. 3(c), the optical waveguide pattern formed on the first mask layer 301 is transferred to the electro-optic material layer 104 through dry etching to form the electro-optic material core 105; the top and sidewalls of the electro-optic material core 105 can be rough structures, enabling waveguide preparation where propagation loss is independent of surface roughness of the electro-optic material core in subsequent steps.

In an embodiment, dry etching can adopt bombardment of an Art plasma to form the electro-optic material core 105.

In an embodiment, the top portion of the electro-optic material core 105 can withstand over-etching caused by excessive bombardment of the Art plasma.

S4: As shown in FIG. 3(d), the first mask layer 301 is removed to form the silicon-rich silicon nitride layer 103 around and on top of the electro-optic material core 105.

In an embodiment, the composition of silicon-rich silicon nitride (SiₓN_{y}) can be adjusted based on the measured refractive index of the electro-optic material core 105 for refractive index matching. The matching conditions must satisfy:

$$\vert {n}_{silicon - rich silicon nitride} ( x , y , λ ) - {n}_{electro - optic material} ( λ ) \vert \leq 0.1$$

where n_{silicon-rich silicon nitride} represents a real part of the material refractive index of the silicon-rich silicon nitride, n_{electro-optic material} (λ) represents a real part of the material refractive index of the electro-optic material, x represents a silicon content ratio in the silicon-rich silicon nitride, y represents a nitrogen content ratio in the silicon-rich silicon nitride, and λ represents an operating optical wavelength designed for the waveguide structure.

In an embodiment, the thickness range of the silicon-rich silicon nitride layer 103 is 0.1-2 micrometers.

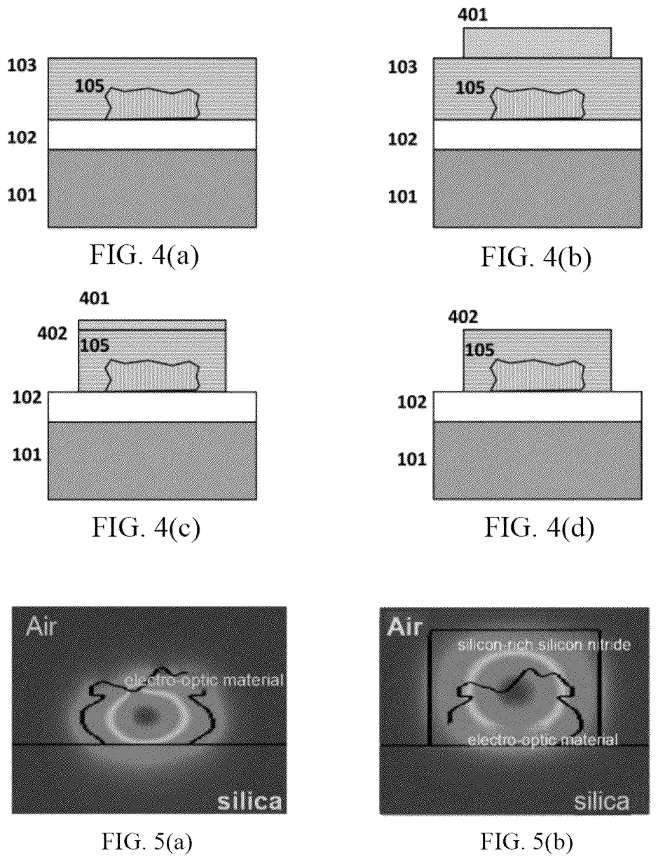

S5: As shown in FIG. 4(a), planarization is performed on the silicon-rich silicon nitride layer 103 to obtain a smooth wafer surface.

In an embodiment, the planarization of the silicon-rich silicon nitride layer 103 can be achieved by chemical mechanical polishing, during which an acidic suspension of CeO₂ substrate may be used.

In an embodiment, the surface roughness of the polished wafer should reach a root mean square value less than or equal to 1 nm, with an observation area of at least 10×10 μm² on the wafer surface.

S6: As shown in FIG. 4(b), a second mask layer 401 is formed on the silicon-rich silicon nitride layer 103, and the optical waveguide pattern is transferred to the second mask layer 401 through photoetching.

In an embodiment, the desired optical waveguide pattern can be formed for the second mask layer 401 by using photoresist or electron beam resist through steps such as spin-coating, curing, exposure, and development.

In an embodiment, after the etching process is completed, the remaining second mask layer 401 should uniformly and integrally cover the silicon-rich silicon nitride layer 103.

S7: As shown in FIG. 4(c), the optical waveguide pattern is transferred from the second mask layer 401 to the silicon-rich silicon nitride layer 103 through etching, forming a silicon-rich silicon nitride cladding structure 402.

In an embodiment, dry etching should be selected, and the etching reaction gases include but are not limited to Ar, He, SF₆/O₂, SF₆/He, SF₆/O₂/He, etc.

S8: As shown in FIG. 4(d), the second mask layer 401 is removed and the wafer is cleaned to obtain a compound waveguide structure with an electro-optic material core.

In an embodiment, an additional ashing process should be performed after wafer cleaning to remove residual impurities on the surface and in the etched channels.

In an embodiment, the barrier material of the first mask layer 301 has a wider selection range compared to that of the second mask layer 401. This is because, in this disclosure, the preparation of the electro-optic material layer is only considered in the preparation of the core region, where its thickness, width, and surface roughness do not affect the subsequent preparation of the cladding structure. When selecting the barrier material, it is often necessary to ensure a sufficiently high etch selectivity ratio (defined as the ratio of the etched thickness of the target material to that of the barrier material within the same time) to prevent irregular patterns on the target material surface caused by premature etching of the barrier layer. Generally, the etch selectivity ratio should be greater than or equal to 2. In this disclosure, the etch selectivity ratio of the first mask layer 301 only needs to exceed 1. Note that, in this embodiment, the role of the first mask layer 301 is solely to form the electro-optic material core 105 structure with sufficient step thickness, and the electro-optic material core 105 does not need to be entirely enclosed within the subsequently deposited silicon-rich silicon nitride cladding structure 402. Based on the optical waveguide pattern designed for the application scenario of the waveguide structure, the presence of the electro-optic material core 105 within the silicon-rich silicon nitride cladding structure 402 can be selectively adjusted to mitigate etching pattern adhesion caused by dense patterns and the accumulation of etching byproducts in trench structures.

In an embodiment, during the formation of the first mask layer 301, there is no strict requirement that the barrier material for the etching gas must be photoresist or electron beam resist. Since the electro-optic material core 105 formed by the first mask layer 301 has very low requirements for sidewall and top surface roughness, its internal waveguide modes are not actually utilized in the waveguide structure. As shown in FIG. 5(a), in the presence of only the electro-optic material core 105, the rough sidewalls caused by etching and the unpolished surface of the electro-optic material film jointly result in non-uniform waveguide mode distribution (taking the C-band as an example) and mode leakage within the electro-optic material core 105. Such waveguide modes introduce significant optical energy loss and are unsuitable for the fabrication and evaluation of optical waveguides.

In an embodiment, when the silicon-rich silicon nitride cladding structure 402 is formed by transferring the optical waveguide pattern of the second mask layer 401, the correction of waveguide modes in the optical waveguide can be achieved by refractive index matching between the silicon-rich silicon nitride material and the electro-optic material (using lithium niobate as an example, including but not limited to lithium tantalate and other inorganic electro-optic materials). As shown in FIG. 5(b), after the formation of the silicon-rich silicon nitride cladding structure 402, the waveguide mode distribution in the optical waveguide is redistributed into the silicon-rich silicon nitride cladding structure 402 after refractive index matching. In this example, the refractive index difference between the silicon-rich silicon nitride and the electro-optic material is 0.1, and the specific value can be adjusted according to the actual refractive index of the electro-optic material used and the tolerance for insertion loss. During the deposition process of silicon-rich silicon nitride, the silicon-rich silicon nitride layer 103 may exhibit refractive index shifts due to variations and fluctuations in temperature, gas pressure, and gas composition within the reaction chamber, resulting in refractive index distributions such as continuous steps, spikes, valleys, or their random combinations. As seen in FIG. 5(b), even with refractive index differences, the light field localization effect and waveguide mode distribution remain highly stable. Therefore, this example demonstrates sufficient fault tolerance even when refractive indices cannot be perfectly matched, making it applicable to production scenarios where precise material refractive index matching is unattainable, while further reducing production costs.

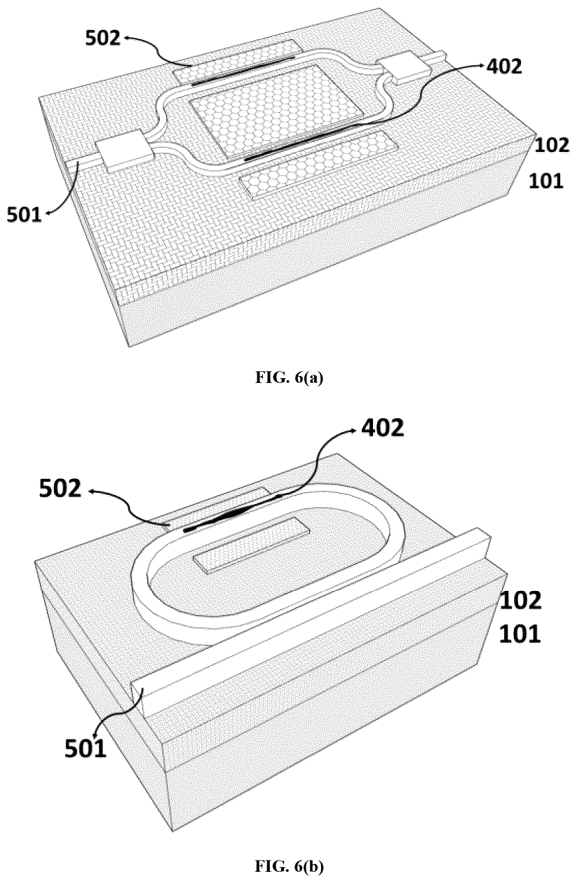

Next, two device structures implemented on the optical chip platform based on this type of waveguide structure are described, as shown in FIGS. 6(a) and 6(b). In both device structures, lithium niobate crystals are used as the electro-optic material for illustration.

In FIG. 6(a), an electro-optic modulator structure implemented using the classic Mach-Zehnder (Mach-Zender) configuration is introduced. In this structure, the optical signal is transmitted through the silicon-rich silicon nitride waveguide structure 501 into the silicon-rich silicon nitride cladding structure 402. Planar electrodes 502, which can be made of gold, silver, or other common metal materials, are distributed on both sides of the silicon-rich silicon nitride cladding structure 402. Since silicon-rich silicon nitride does not exhibit an electro-optic effect, the voltage division on the electro-optic material core 105 within the silicon-rich silicon nitride cladding structure 402 can be adjusted by applying voltage to the planar electrodes. Leveraging the electro-optic effect of a lithium niobate material, zero-static-power optical phase modulation can be achieved.

In FIG. 6(b), an electro-optic modulator structure implemented using a micro-ring configuration is introduced. In this structure, the phase modulation of the optical signal may also be achieved through the electro-optic effect provided by the electro-optic material core 105.

In an embodiment, for the micro-ring structure shown in FIG. 6(b), the electro-optic material core 105 can provide additional second-order nonlinear optical effects compared to silicon-rich silicon nitride materials, making it more suitable for flexibly realizing high-Q nonlinear optical resonators based on micro-ring or racetrack-shaped micro-ring structures. Such resonators have been widely used in the preparation of optical frequency combs and high-quality narrow-linewidth lasers.

In an embodiment, for the micro-ring structure shown in FIG. 6(b), its coupling region consists of a silicon-rich silicon nitride waveguide structure 501, whose etching process is simpler compared to the electro-optic material core 105, and sidewall smoothness control is also easier.

Furthermore, in optoelectronic device structures that do not include the planar electrode 502, the electro-optic material core 105 can serve as a nonlinear optical gain material. By introducing second-or-third-order nonlinear optical effects, functions such as optical frequency mixing and optical difference/doubling frequency can be achieved.

The above descriptions are merely preferred embodiments of the present disclosure. Although the present disclosure has been disclosed above through exemplary embodiments, it is not intended to limit the present disclosure. Any person skilled in the art, without departing from the scope of the technical solutions of the present disclosure, may use the methods and technical content disclosed above to make many possible modifications and variations to the technical solutions of the present disclosure, or modify them into equivalent embodiments with similar changes. Therefore, any simple modifications, equivalent changes, and variations made to the above embodiments based on the technical essence of the present disclosure, without departing from the content of the technical solutions of the present disclosure, shall still fall within the protection scope of the technical solutions of the present disclosure.

What is claimed is:

1. A preparation method for a compound waveguide structure with an electro-optic material core, comprising following steps:
step S1, providing an electro-optic-film-on-insulator wafer;
step S2, forming a first mask layer on the electro-optic-film-on-insulator wafer;
step S3, transferring an optical waveguide pattern formed on the first mask layer to an electro-optic material layer of the electro-optic-film-on-insulator wafer by dry etching to form an electro-optic material core;
step S4, removing the first mask layer, and forming a silicon-rich silicon nitride layer around and on a top of the electro-optic material core, wherein a material in the silicon-rich silicon nitride layer satisfies a refractive index matching with an electro-optic material in the electro-optic material core; and adjusting a composition of silicon-rich silicon nitride based on a measured refractive index of the electro-optic material core to achieve the refractive index matching, wherein the refractive index satisfies:
$$\vert {n}_{silicon - rich silicon nitride} ( x , y , λ ) - {n}_{electro - optic material} ( λ ) \vert \leq 0.1$$
where n_{silicon-rich silicon nitride} represents a real part of a material refractive index of the silicon-rich silicon nitride, n_{electro-optic material} (λ) represents a real part of a material refractive index of the electro-optic material, x represents a silicon content ratio in the silicon-rich silicon nitride, y represents a nitrogen content ratio in the silicon-rich silicon nitride, and λ represents an operating optical wavelength designed for the compound waveguide structure;
step S5, performing a planarization treatment on the silicon-rich silicon nitride layer to obtain a smooth wafer surface;
step S6, forming a second mask layer on the silicon-rich silicon nitride layer, and transferring the optical waveguide pattern to the second mask layer by photoetching;
step S7, transferring the optical waveguide pattern on the second mask layer to the silicon-rich silicon nitride layer by etching to form a silicon-rich silicon nitride cladding structure; and
step S8, removing the second mask layer and cleaning the electro-optic-film-on-insulator wafer to obtain the compound waveguide structure with the electro-optic material core.

2. The preparation method according to claim 1, wherein the electro-optic material core is not entirely contained within the silicon-rich silicon nitride cladding structure; and based on the optical waveguide pattern designed for an application scenario of the compound waveguide structure, selective adjustment is made to determine whether the silicon-rich silicon nitride cladding structure contains the electro-optic material core.

3. The preparation method according to claim 1, wherein the electro-optic-film-on-insulator wafer sequentially comprises a silicon substrate layer, an insulator, and the electro-optic material layer that are arranged from bottom to top; and the electro-optic material layer is prepared through He⁺ or H+ ion implantation followed by heating and delamination, without subsequent chemical mechanical polishing to achieve a flat surface.

4. The preparation method according to claim 1, wherein the first mask layer is configured to form the electro-optic material core having a sufficient thickness step, and the second mask layer ensures that the remaining second mask layer uniformly and integrally covers the silicon-rich silicon nitride layer after an etching process.

5. The preparation method according to claim 1, wherein the electro-optic material core is formed by bombardment of an Ar⁺ plasma, and a top portion of the electro-optic material core is capable of withstanding over-etching caused by excessive bombardment of the Ar⁺ plasma.

6. A method of using the compound waveguide structure with the electro-optic material core prepared by the preparation method according to claim 1 in optoelectronic devices, comprising implementing an optical phase adjustment using a planar electrode through an electro-optic effect provided by the electro-optic material core.

7. A method of using the compound waveguide structure with the electro-optic material core prepared by the preparation method according to claim 1 in optoelectronic devices, comprising using the electro-optic material core as a nonlinear optical gain material to implement optical frequency mixing and optical difference/doubling frequency functionality by introducing nonlinear optical effect.
